(19) United States
(12) Patent Application Publication
(10) Pub. No.: US 2025/0324393 A1
(43) Pub. Date: Oct. 16, 2025

(54) TECHNIQUES FOR IDLE OR INACTIVE STATE TRAJECTORY PREDICTIONS

(71) Applicant: QUALCOMM Incorporated, San Diego, CA (US)

(72) Inventors: Navid ABEDINI, Basking Ridge, NJ (US); Hua WANG, Basking Ridge, NJ (US); Junyi LI, Greentown, PA (US)

(21) Appl. No.: 18/636,990

(22) Filed: Apr. 16, 2024

(51) Int. Cl. H04W 64/00; H04B 17/318; H04W 76/10; H04W 76/20

(52) U.S. Cl. CPC H04W 64/006; H04B 17/328; H04W 76/10; H04W 76/20

(57) ABSTRACT

Methods, systems, and devices for wireless communications are described. Some wireless communications systems may support various techniques to track or otherwise obtain updated information regarding the current or future location of a user equipment (UE) that moves through one or more zones or coverage areas located in the wireless communications system. The UE may obtain predicted trajectory information that includes information associated with the predicted trajectory of the UE while the UE operates in an idle or inactive state. The predicted trajectory information may indicate at least at least one predicted zone associated with the UE at a time instance after obtaining the predicted trajectory information. Based on receiving the predicted trajectory information, the UE may communicate location information with one or more network entities, where the location information is indicative of one or more location or trajectory characteristics of the UE.

### FIELD OF TECHNOLOGY

The following relates to wireless communications, including techniques for idle or inactive state trajectory predictions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for idle or inactive state trajectory predictions. For example, the described techniques provide a framework for accurately predicting a future trajectory of a user equipment (UE) and applying the trajectory prediction to improve UE tracking within a wireless communications system. For example, some wireless communications systems may support various techniques to track or otherwise obtain updated location information regarding the current or future location of the UE that moves through one or more zones or coverage areas. In some cases, the UE may obtain (e.g., via one or more machine learning or artificial intelligence (AI) models implemented at the UE or at a network entity) predicted trajectory information that includes information associated with the predicted trajectory of the UE while the UE operates in an idle or inactive state. In some examples, the predicted trajectory information may indicate at least at least one predicted zone associated with the UE at a time instance after obtaining the predicted trajectory information. Then, based on receiving the predicted trajectory information, the UE may communicate location information with one or more network entities, where the location information is indicative of one or more location or trajectory characteristics of the UE.

A method for wireless communication by a UE is described. The method may include obtaining predicted trajectory information associated with the UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information and communicating, with a network entity, location information that is indicative of a location of the UE, the location information being based on the predicted trajectory information.

A UE for wireless communication is described. The UE may include one or more memories storing processor executable code, and one or more processors coupled with the one or more memories. The one or more processors may individually or collectively be operable to execute the code to cause the UE to obtain predicted trajectory information associated with the UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information and communicate, with a network entity, location information that is indicative of a location of the UE, the location information being based on the predicted trajectory information.

Another UE for wireless communication is described. The UE may include means for obtaining predicted trajectory information associated with the UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information and means for communicating, with a network entity, location information that is indicative of a location of the UE, the location information being based on the predicted trajectory information.

A non-transitory computer-readable medium storing code for wireless communication is described. The code may include instructions executable by one or more processors to obtain predicted trajectory information associated with the UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information and communicate, with a network entity, location information that is indicative of a location of the UE, the location information being based on the predicted trajectory information.

In some examples of the method, UEs, and non-transitory computer-readable medium described herein, obtaining the predicted trajectory information may include operations, features, means, or instructions for receiving an indication of the predicted trajectory information from at least one network entity, where the at least one network entity may be associated with a previous serving cell of the UE, a cell on which the UE may be camped, a service of a core network of a wireless communication system associated with the UE, or any combination thereof.

In some examples of the method, UEs, and non-transitory computer-readable medium described herein, receiving the indication may include operations, features, means, or instructions for receiving the indication while operating in a connected mode associated with an active connection between the UE and the network entity and transitioning, after receiving the indication, from the connected mode to the idle or inactive mode.

In some examples of the method, UEs, and non-transitory computer-readable medium described herein, receiving the indication may include operations, features, means, or instructions for receiving the indication based on a change in the location of the UE from a first zone to a second zone.

In some examples of the method, UEs, and non-transitory computer-readable medium described herein, obtaining the predicted trajectory information may include operations, features, means, or instructions for obtaining the predicted trajectory information based on a machine learning model that may be deployed at the UE.

In some examples of the method, UEs, and non-transitory computer-readable medium described herein, communicating the location information may include operations, features, means, or instructions for transmitting an indication of the predicted trajectory information to the network entity.

In some examples of the method, UEs, and non-transitory computer-readable medium described herein, transmitting the indication may include operations, features, means, or instructions for transmitting the indication while the UE operates in a connected mode associated with an active connection between the UE and the network entity and transitioning, after transmitting the indication, from the connected mode to the idle or inactive mode.

In some examples of the method, UEs, and non-transitory computer-readable medium described herein, transmitting the indication may include operations, features, means, or instructions for establishing an active connection with the network entity and transmitting the indication to the network entity based on establishing the active connection.

In some examples of the method, UEs, and non-transitory computer-readable medium described herein, transmission of the indication may be in accordance with a procedure for updating the location of the UE.

Some examples of the method, UEs, and non-transitory computer-readable medium described herein may further include operations, features, means, or instructions for receiving, from the network entity, a periodicity indicator associated with the procedure, where transmission of the indication may be in accordance with a periodicity indicated by the periodicity indicator.

Some examples of the method, UEs, and non-transitory computer-readable medium described herein may further include operations, features, means, or instructions for transmitting, to the network entity, an indicator of one or more parameters corresponding to the procedure, where transmitting the indication may be in accordance with the one or more parameters.

In some examples of the method, UEs, and non-transitory computer-readable medium described herein, transmitting the indication may include operations, features, means, or instructions for transmitting the indication based on an actual trajectory of the UE while the UE operates in the idle or inactive mode, where the actual trajectory deviates from the predicted trajectory.

In some examples of the method, UEs, and non-transitory computer-readable medium described herein, communicating the location information may include operations, features, means, or instructions for transmitting, to the network entity, an indication of whether the location of the UE at the time instance may be consistent with the predicted trajectory information, the indication including the location information.

In some examples of the method, UEs, and non-transitory computer-readable medium described herein, the predicted zone includes a cell, a tracking area, a radio access network (RAN) notification area, a beam, or one or more geo-location coordinates.

In some examples of the method, UEs, and non-transitory computer-readable medium described herein, the predicted zone corresponds to one or more signal strength measurement parameters.

In some examples of the method, UEs, and non-transitory computer-readable medium described herein, the predicted zone corresponds to a result of a sensing procedure at the UE.

In some examples of the method, UEs, and non-transitory computer-readable medium described herein, the predicted trajectory information may be further indicative of a respective duration the location of the UE may be predicted to be associated with the predicted zone, the time instance being within the respective duration.

In some examples of the method, UEs, and non-transitory computer-readable medium described herein, the time instance may be a first time instance, the location of the UE at a second time instance before the first time instance may be associated with the predicted zone, and the predicted trajectory information further indicates a duration over which the location of the UE may be predicted to be associated with the predicted zone.

A method for wireless communication by a network entity is described. The method may include obtaining predicted trajectory information associated with a UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information and communicating location information that is indicative of a location of the UE, the location information being based on the predicted trajectory information.

A network entity for wireless communication is described. The network entity may include one or more memories storing processor executable code, and one or more processors coupled with the one or more memories. The one or more processors may individually or collectively be operable to execute the code to cause the network entity to obtain predicted trajectory information associated with a UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information and communicate location information that is indicative of a location of the UE, the location information being based on the predicted trajectory information.

Another network entity for wireless communication is described. The network entity may include means for obtaining predicted trajectory information associated with a UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information and means for communicating location information that is indicative of a location of the UE, the location information being based on the predicted trajectory information.

A non-transitory computer-readable medium storing code for wireless communication is described. The code may include instructions executable by one or more processors to obtain predicted trajectory information associated with a UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information and communicate location information that is indicative of a location of the UE, the location information being based on the predicted trajectory information.

In some examples of the method, network entities, and non-transitory computer-readable medium described herein, communicating the location information may include operations, features, means, or instructions for outputting an indication of the predicted trajectory information to the UE or at least one other network entity.

In some examples of the method, network entities, and non-transitory computer-readable medium described herein, outputting the indication may include operations, features, means, or instructions for outputting the indication based on an active connection between the UE and the network entity and determining to release the active connection between the UE and the network entity after outputting the indication.

In some examples of the method, network entities, and non-transitory computer-readable medium described herein, outputting the indication may include operations, features, means, or instructions for outputting the indication based on a change in the location of the UE from a first zone to a second zone.

In some examples of the method, network entities, and non-transitory computer-readable medium described herein, obtaining the predicted trajectory information may include operations, features, means, or instructions for obtaining an indication of the predicted trajectory information from the UE or at least one other network entity.

In some examples of the method, network entities, and non-transitory computer-readable medium described herein, the indication may be obtained from the at least one other network entity and the method, apparatuses, and non-transitory computer-readable medium may include further operations, features, means, or instructions for outputting a paging signal to the UE in response to obtaining the indication.

In some examples of the method, network entities, and non-transitory computer-readable medium described herein, obtaining the indication may include operations, features, means, or instructions for obtaining the indication from the UE via an active connection between the UE and the network entity and determining to release the active connection between the UE and the network entity after obtaining the indication.

In some examples of the method, network entities, and non-transitory computer-readable medium described herein, the indication may be obtained from the UE in accordance with a procedure for updating the location of the UE.

Some examples of the method, network entities, and non-transitory computer-readable medium described herein may further include operations, features, means, or instructions for outputting a periodicity indicator associated with the procedure, where the indication may be obtained in accordance with a periodicity indicated by the periodicity indicator.

Some examples of the method, network entities, and non-transitory computer-readable medium described herein may further include operations, features, means, or instructions for obtaining an indicator of one or more parameters corresponding to the procedure, where the indication may be obtained in accordance with the one or more parameters.

In some examples of the method, network entities, and non-transitory computer-readable medium described herein, obtaining the indication may include operations, features, means, or instructions for obtaining the indication based on an actual trajectory of the UE while the UE operates in the idle or inactive mode, where the actual trajectory deviates from the predicted trajectory.

In some examples of the method, network entities, and non-transitory computer-readable medium described herein, communicating the location information may include operations, features, means, or instructions for obtaining an indication of whether the location of the UE at the time instance may be consistent with the predicted trajectory information, the indication including the location information.

In some examples of the method, network entities, and non-transitory computer-readable medium described herein, the predicted zone includes a cell, a tracking area, a RAN notification area, a beam, or one or more geo-location coordinates.

In some examples of the method, network entities, and non-transitory computer-readable medium described herein, the predicted zone corresponds to one or more signal strength measurement parameters.

In some examples of the method, network entities, and non-transitory computer-readable medium described herein, the predicted trajectory information may be further indicative of a respective duration the location of the UE may be predicted to be associated with the predicted zone, the time instance being within the respective duration.

In some examples of the method, network entities, and non-transitory computer-readable medium described herein, the time instance may be a first time instance, the location of the UE at a second time instance before the first time instance may be associated with the predicted zone, and the predicted trajectory information further indicates a duration over which the location of the UE may be predicted to be associated with the predicted zone.

### BRIEF DESCRIPTION OF THE DRAWINGS

FIGS. 1, 2, and 3 show examples of wireless communications systems that support techniques for idle or inactive state trajectory predictions in accordance with one or more aspects of the present disclosure.

FIG. 4 shows an example of a process flow that supports techniques for idle or inactive state trajectory predictions in accordance with one or more aspects of the present disclosure.

FIGS. 5 and 6 show block diagrams of devices that support techniques for idle or inactive state trajectory predictions in accordance with one or more aspects of the present disclosure.

FIG. 7 shows a block diagram of a communications manager that supports techniques for idle or inactive state trajectory predictions in accordance with one or more aspects of the present disclosure.

FIG. 8 shows a diagram of a system including a device that supports techniques for idle or inactive state trajectory predictions in accordance with one or more aspects of the present disclosure.

FIGS. 9 and 10 show block diagrams of devices that support techniques for idle or inactive state trajectory predictions in accordance with one or more aspects of the present disclosure.

FIG. 11 shows a block diagram of a communications manager that supports techniques for idle or inactive state trajectory predictions in accordance with one or more aspects of the present disclosure.

FIG. 12 shows a diagram of a system including a device that supports techniques for idle or inactive state trajectory predictions in accordance with one or more aspects of the present disclosure.

FIGS. 13 through 16 show flowcharts illustrating methods that support techniques for idle or inactive state trajectory predictions in accordance with one or more aspects of the present disclosure.

### DETAILED DESCRIPTION

A wireless device such as a user equipment (UE) may be capable of moving between or accessing different zones or cells within a wireless communications system. For example, the UE may move through a series of zones or cells, and the movements of the UE may be described by or otherwise referred to as a “trajectory” of the UE. In some cases, the UE may operate in an active or connected state, where based on registration with the network, the UE may receive an indication of a registration area that includes a set of tracking areas configured for the UE. In such cases, the network may keep track of the UE as it moves throughout the set of tracking areas. In some other cases, however, the UE may enter an idle or inactive state where the UE and may no longer have an active connection with the network.

While operating in an idle or inactive state, the UE may still be capable of moving throughout different zones or cells, which may pose challenges for UE tracking, signaling overhead, handover, and trajectory prediction. In some implementations, to identify and predict the mobility state and trajectory of the UE, the network or the UE may use artificial intelligence (AI) or machine learning techniques, among other techniques, to predict the trajectory of the UE more effectively. For example, using a predicted trajectory of UE operating in an idle or inactive state may reduce network power expenditure and signaling overhead, for example, by reducing the area over which the network needs to page the UE based on the prediction, and by reducing the total quantity of paging transmissions communicated between the UE and the network. Additionally or alternatively the trajectory prediction of the UE through different zones or tracking areas may reduce the overhead of the tracking update signaling of the UE, since the network entity may be able to predict the location of the UE rather than sending paging signaling.

In some implementations, the UE may use the one or more AI models, machine learning models, or both, to predict its own trajectory and then may report the predicted trajectory to the network. Additionally, or alternatively, the network may use the one or more AI models, machine learning models, or both, to predict the trajectory of the UE, and may provide the predicted trajectory to the UE. In some examples, the predicted trajectory may be based on prior UE measurements, a previously reported location of the UE, a mobility history of the UE, or any combination thereof.

In some aspects, the predicted trajectory of the UE may correspond to one or more cells or zones that the UE predicted to visit, which may be further defined based on one or more different spatial characteristics. For example, a zone associated with the predicted trajectory may correspond to one or more beams or areas of spatial coverage that are predicted to be associated with a location of the UE at a future time instance. In some examples, a zone associated with the predicted trajectory of the UE may correspond to predicted geo-location coordinates of the UE at a future time instance. In some examples, a zone may be associated with a combination of signal strength measurement parameters reported or received by the UE. In some examples, a zone may be associated with one or more results of one or more sensing procedures performed by the UE.

Aspects of the disclosure may be implemented to realize one or more potential advantages. For example, as described herein, the UE trajectory prediction may reduce signaling overhead both at the UE and at the network since the UE may transmit relatively fewer tracking area update messages (e.g., to update the network regarding a new location of the UE) and the network may send relatively fewer paging messages to the UE to identify new or updated locations of the UE. Relatedly, the reduced signaling may reduce the overall power expenditure by both the UE and the network. For example, the UE may remain in an idle or inactive state for a longer duration, and may not need to wake up or re-establish a connection with the network in order to transmit tracking update signaling. Additionally, or alternatively, the techniques described herein may support integrated tracking across multiple different zones or cells in a wireless communication system, and may enhance different techniques such as handover, among other techniques.

Aspects of the disclosure are initially described in the context of wireless communications systems. Aspects of the disclosure are further illustrated by and described with reference to a process flow apparatus diagrams, system diagrams, and flowcharts that relate to techniques for idle or inactive state trajectory predictions.

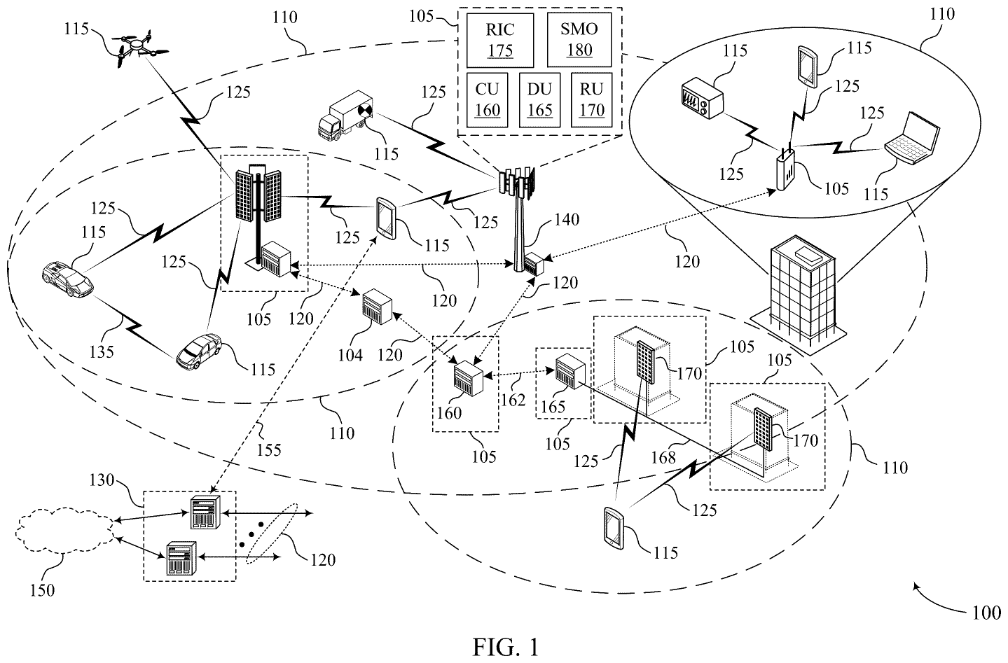

FIG. 1 shows an example of a wireless communications system 100 that supports techniques for idle or inactive state trajectory predictions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A UE 115 may be capable of moving between different zones or cells within the wireless communications system 100. For example, the UE 115 may move through a series of zones or cells, and the movements of the UE may be described by or otherwise referred to as a UE trajectory or a trajectory of the UE 115. In some cases, the UE 115 may operate in an active or connected state, where the network may keep track of the UE 115 as it moves throughout a set of configured tracking areas. In some other cases, however, the UE 115 may enter an idle or inactive state where the UE 115 and may no longer have an active connection with the network.

While operating in an idle or inactive state, the UE 115 may still be capable of moving throughout different zones or cells, which may pose challenges for UE tracking, signaling overhead, and trajectory prediction. In some implementations, to identify and predict the mobility state and trajectory of the UE 115, the network or the UE 115 may implement AI or machine learning techniques, among other techniques, to predict the trajectory of the UE 115 as it moves in an idle or inactive state. In some implementations, the UE 115 may use the one or more AI models, machine learning models, or both, to predict its own trajectory and then may report the predicted trajectory to the network. Additionally, or alternatively, a network entity 105 may use the one or more AI models, machine learning models, or both, to predict the trajectory of the UE 115, and may provide the predicted trajectory to the UE 115. In some examples, the predicted trajectory may be based on prior UE measurements, a previously reported location of the UE 115, a mobility history of the UE 115, or any combination thereof.

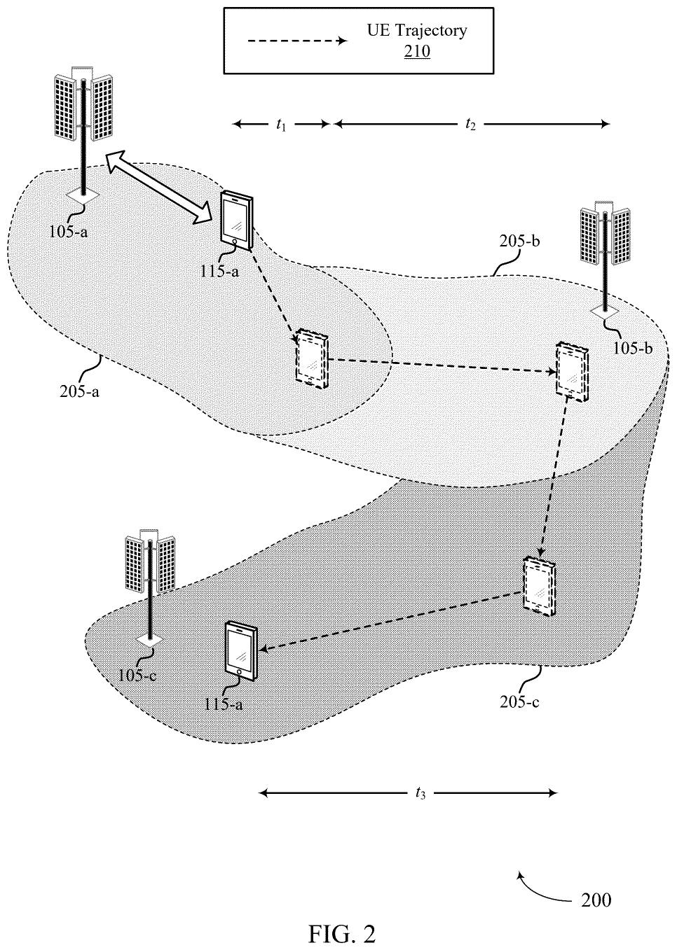

FIG. 2 shows an example of a wireless communications system 200 that supports techniques for idle or inactive state trajectory predictions in accordance with one or more aspects of the present disclosure. For example, the wireless communications system 200 illustrates communications between a UE 115-a and a network entity 105-a, each of which may be examples of UEs 115 and network entities 105 described with reference to FIG. 1. In some aspects, the UE 115-a may also communicate with other network entities, including network entity 105-b and network entity 105-c, each of which may be examples of network entities 105 described with reference to FIG. 1. The wireless communications system 200 may include one or more “zones” or coverage areas that the UE 115-a may access or otherwise travel between, including a first zone 205-a, a second zone 205-b, and a third zone 205-c.

The UE 115-a may be capable of moving between or accessing different zones or cells within the wireless communications system 200. For example, the UE 115-a may move through a series of zones or cells, and the movements of the UE 115-a may be described by or otherwise referred to as a trajectory of the UE 115-a. In some implementations, the UE 115-a may operate in an active state (e.g., an RRC active state) and may maintain an active connection with the network entity 105-a. Based on registration with the network entity 105-a, for example, the UE 115-a may receive an indication of a registration area that includes a set of tracking areas configured for the UE 115-a, and the network entity 105-a may keep track of the UE 115-a as it moves throughout the set of tracking areas configured by the network. In some cases, however, the UE 115-a may enter an idle or inactive mode (e.g., RRC idle or RRC inactive), and may no longer have an active connection with the network entity 105-a.

The UE 115-a, however, may still be capable of moving throughout different zones or cells while in an idle or inactive state, which may pose challenges for UE tracking, handover, and trajectory prediction. In some implementations, to more effectively identify and predict the mobility state and trajectory of the UE 115-a, the network entity 105-a (or another device) may use AI or machine learning techniques, among other techniques, to predict the trajectory of the UE 115-a operating in an idle or inactive state. For example, using a predicted trajectory of UE operating in an idle or inactive state may reduce network power expenditure and signaling overhead, for example, by reducing the area over which the network entity 105-a needs to page the UE 115-a based on the prediction, and by reducing the total quantity of paging transmissions (in multiple cells and by multiple beams) that the UE 115-a and the network entity 105-a communicate with one another. Additionally, or alternatively, the predicted trajectory may allow the network entity 105-a to assign a smaller tracking area (TA) or RAN notification areas (RNA) to the UE 115-a, which may reduce the paging overhead incurred by the network entity 105-a while increasing the quantity of tracking update signaling performed by the UE 115-a as it moves through relatively smalling tracking areas. The trajectory prediction of the UE 115-a through the tracking areas may reduce the overhead of the tracking update signaling of the UE 115-a, since the network entity 105-a may be able to predict the location of the UE 115-a.

Mobility enhancement and trajectory prediction of the UE 115-a may also allow the network entity 105-a (e.g., the source cell for the UE 115-a) to make a more informed decision regarding a possible handover of the UE 115-a. For example, the network entity 105-a may be able to predict that the UE 115-a will move from the first zone 205-a to the second zone 205-b, and may transmit a handover request or other signaling to the network entity 105-b associated with the second zone 205-b. The trajectory prediction may also predict the movement of the UE 115-a from the second zone 205-b to the third zone 205-c, and the network entity 105-b may send additional handover information and a second handover request for the UE 115-a as it moves from the second zone 205-b to the third zone 205-c. Additionally, or alternatively, the trajectory prediction of the UE 115-a may include “time to stay” information related to a time period in which the UE 115-a is predicted to stay within one or more of the zones. In some aspects, the network entity 105-a may share the “time to stay” information with other network devices within the wireless communications system 100, such as with the network entity 105-b, the network entity 105-c, or both.

In order to enable efficient and accurate tracking and reduced signaling overhead for the UE 115-a in an idle or inactive state, the wireless communications system 200 may support various signaling that may enable the UE 115-a to report or obtain a prediction of the trajectory of the UE 115-a (e.g., while the UE 115-a operates an idle or inactive state). For example, the UE 115-a may use one or more AI models, machine learning models, or both, to predict its own trajectory and then may report the predicted trajectory to the network entity 105-a. Additionally, or alternatively, the network entity may use one or more AI models, machine learning models, or both, to predict the trajectory of the UE 115-a, and may provide the predicted trajectory to the UE 115-a via downlink signaling. In some examples, the predicted trajectory may be based on prior UE measurements, a previously reported location of the UE 115-a, a mobility history of the UE 115-a, or any combination thereof.

In some aspects, the predicted trajectory of the UE 115-a may correspond to one or more of the first zone 205-a, the second zone 205-b, the third zone 205-c, or other zones that the UE 115-a may access. In some examples, the first zone 205-a, the second zone 205-b and the third zone 205-c may be included in a list of multiple cells or zones that the UE 115-a is predicted to visit, where the list also includes an expected “time-to-stay” or time of visit per cell or zone. For example, the expected “time-to-stay” of the UE 115-a in the first zone 205-a may be t1, the expected “time-to-stay” of the UE 115-a in the second zone 205-b may be t2, and the expected “time-to-stay” of the UE 115-a in the third zone 205-c may be t3. In some aspects, the predicted trajectory of the UE 115-a may correspond to a cell, a TA, or an RNA the UE 115-a is predicted to be located in at a future time instance.

Additionally, or alternatively, the different zones associated with the predicted trajectory may be defined based on one or more different spatial characteristics. For example, a zone associated with the predicted trajectory may correspond to one or more beams (e.g., a set of SSB beams associated with one or more cells) or areas of spatial coverage (at a beam-level granularity) that are predicted to be associated with a location of the UE 115-a at a future time instance. In some examples, a zone associated with the predicted trajectory of the UE 115-a may correspond to predicted geo-location coordinates of the UE 115-a at a future time instance. In some examples, a zone may be associated with a combination of signal strength measurement parameters reported or received by the UE 115-a, for example, if the UE 115-a receives a signal from a cell that has a signal strength that exceeds a threshold, then the cell may be included in a zone. In some examples, a zone may be associated with one or more results of one or more sensing procedures performed by the UE 115-a. For example, the UE 115-a may be capable of sensing the environment, and information collected by the UE 115-a may be mapped to a zone index such as a logical zone index.

In some aspects, the UE 115-a may report (or obtain) the predicted trajectory before transitioning from a connected mode to the idle or inactive mode, or UE 115-a may report (or obtain) the predicted trajectory when the UE 115-a (or the network entity 105-a) predicts that the UE 115-a has entered a new zone. In some aspects, the trajectory prediction may be performed by the UE 115-a, by the network (e.g., by the network entity 105-a, by the network entity 105-b, or by the network entity 105-c), or by other devices in the network, different network functions, or in a cloud environment.

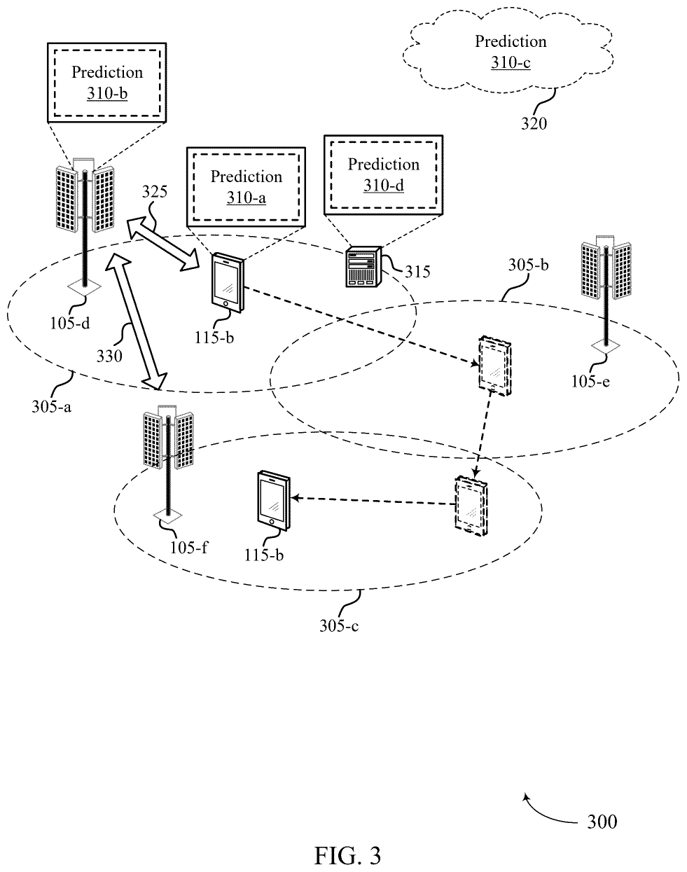

FIG. 3 shows an example of a wireless communications system 300 that supports techniques for idle or inactive state trajectory predictions in accordance with one or more aspects of the present disclosure. For example, the wireless communications system 300 illustrates communications between a UE 115-b and a network entity 105-d, each of which may be examples of UEs 115 and network entities 105 described with reference to FIG. 1 and FIG. 2. In some aspects, the UE 115-b may also communicate with other network entities, including network entity 105-e and network entity 105-f, each of which may be examples of network entities 105 described with reference to FIGS. 1 and 2. The wireless communications system 300 may include one or more “zones” or coverage areas that the UE 115-b may access or otherwise travel between, including a first zone 305-a, a second zone 305-b, and a third zone 305-c.

The UE 115-b may be capable of moving between or accessing different zones or cells within the wireless communications system 300. For example, the UE 115-b may move through a series of zones or cells, and the movements of the UE 115-b may be described by or otherwise referred to as a trajectory of the UE 115-b (e.g., UE trajectory 210). In some implementations, the UE 115-b may operate in an active state (e.g., an RRC active state) and may maintain an active connection with the network entity 105-b. In some cases, however, the UE 115-b may enter an idle or inactive mode (e.g., RRC idle or RRC inactive), and may no longer have an active connection with the network entity 105-b.

In order to track or otherwise identify the location of the UE 115-b as it moves through a trajectory while operating in an idle or inactive mode, the wireless communications system 300 may support UE trajectory prediction, where one or more network entities, the UE 115-b, or other network functions may predict the trajectory of the UE using different prediction techniques. The UE prediction may include mobility information and other location information for the UE 115-b during a time instance or over a time duration.

In some aspects, the UE trajectory prediction may be performed by the UE 115-b (e.g., prediction 310-a), the last serving cell or network entity that the UE 115-b was connected with before transitioning to the idle or inactive state (e.g., prediction 310-b), a camped cell of the UE 115-b, a service management function in the network or in the cloud (e.g., via cloud service 320 producing prediction 310-c), an operations and management (OAM) function 315 (e.g., prediction 310-d), or any other network device or network function, or any combination thereof.

In some examples, the UE 115-b may receive a prediction result from an OAM or other core network function, and may run the prediction algorithm to obtain the prediction 310-a. After obtaining the results of the prediction, the UE 115-b may share the prediction 310-a with the network entity 105-d (e.g., via signaling 325). For example, in some cases, the UE 115-b may perform the prediction before entering into the idle or inactive state, and then may share the prediction with the network entity 105-d before entering into the idle or inactive state. Additionally, or alternatively, while operating in the idle or inactive state, the UE 115-b may re-register with the network entity 105-d to provide new or updated trajectory prediction information. For example, the UE 115-b may wake up to transmit additional trajectory prediction information (or updated trajectory prediction information that is supplementary to a previously provided trajectory prediction), or the UE 115-b may re-register with the network entity 105-d in order to provide new trajectory prediction information. In some implementations, the UE 115-b may transmit updated trajectory information in accordance with a periodicity (e.g., the trajectory update procedure may be periodic), where the periodicity may be configured or indicated by the network entity 105-d.

In some other examples, a network entity such as the network entity 105-d (or the last network entity or serving cell that the UE 115-b is connected with before transitioning to the idle or inactive state) may perform or run the prediction (e.g., the network entity 105-d may run one or more machine learning models or algorithms, or may implement one or more AI models or algorithms) to obtain the trajectory prediction for the UE 115-b. In some implementations, the network entity 105-d may share or otherwise output the results of the trajectory prediction to the UE 115-b (e.g., via signaling 325), to one or more other network entities along the trajectory of the UE 115-b (e.g., to the network entity 105-e or to the network entity 105-f via signaling 330), to one or more other devices or network functions of the core network, one or more service functions, among other devises or functions, or any combination of devices and functions. For example, in some cases the UE 115-b or the network entity 105-d may predict that the UE 115-b may remain in the first zone 305-a for a specified time duration (e.g., at least or at most for the next T seconds). The network entity 105-d, the UE 115-b, or both, may share this information of the predicted trajectory of the UE 115-b with other network entities or other devices or services in the wireless communications system 300.

In some examples, the network entity 105-d may output an indication of the trajectory prediction of the UE 115-b to the UE 115-b before the UE 115-b enters the idle or inactive state. Additionally, or alternatively, the network entity 105-d may output the indication of the trajectory prediction when it predicts that the UE 115-b may have entered a new zone or the coverage area associated with a different network entity (e.g., the second zone 305-b or the third zone 305-c). In some cases, the UE 115-b may store the trajectory prediction, and may compare its actual location at a time instance to the predicted location at the same time instance. If the actual location of the UE 115-b matches with the predicted location, the UE 115-b may refrain from signaling a tracking update, which may reduce power expenditure and signaling overhead for the UE 115-b.

For example, in cases where the information about the predicted trajectory of the UE 115-b or the current or future zone of the UE 115-b is available at the network entity 105-d, and in cases the UE 115-b determines that it is following the predicted trajectory, the UE 115-b may skip re-registering and updating its location with the network entity (e.g., when the UE 115-b enters a new zone). Otherwise, if the UE 115-b determines that it has deviated from its predicted trajectory in time, in space, or both, or has otherwise determined that its trajectory may be different from the previously predicted trajectory, the UE 115-b may re-register with one of the network entities and may provide updated location information, mobility information, trajectory information, or a combination thereof. In some such examples, the paging of UE 115-b may be restricted or prioritized over the predicted zone of the UE 115-b at the time of paging.

In some other examples, the core network or the cloud service 320 may perform the trajectory prediction and may output the information to the radio access network or to one or more of the network entities. For example, in addition to or as part of the trajectory prediction, the core network or the cloud service 320 may indicate one or more time instances that the network entities should page the UE 115-b, or one or more time instances where the UE 115-b is predicted to enter a different zone (or become associated with a different network entity).

In some implementations, the different devices that may perform the trajectory prediction may use one or more inputs into a machine learning model, an AI model, or another prediction algorithm. For example, prior measurements taken by the UE 115-b (while the UE 115-b was in a connected state) may be used as inputs into the model. Additionally, or alternatively, the location of the UE 115-b may be used, one or more idle-mode or inactive-mode measurements taken by the UE 115-b, a report of the mobility history of the UE 115-b may be used, a location update or trajectory update procedure of the UE 115-b may be used, among other possible inputs, or any combination thereof.

In some aspects, the UE 115-b may be configured with one or more tracking zones. Additionally, or alternatively, the UE 115-b may be configured with a periodicity that is associated with the UE 115-b periodically sending updated location information or trajectory information to the network. In some examples, the UE 115-b may determine a suggested configuration of different tracking zones, an update periodicity for the trajectory information, or both, and may transmit the suggested configuration to the network entity 105-d. In some other examples, the network entity 105-d (e.g., such as a serving network entity, a network node) may provide the configuration of tracking zones and periodicity to another entity (e.g., a target network entity, core network, an associated service, among other devices).

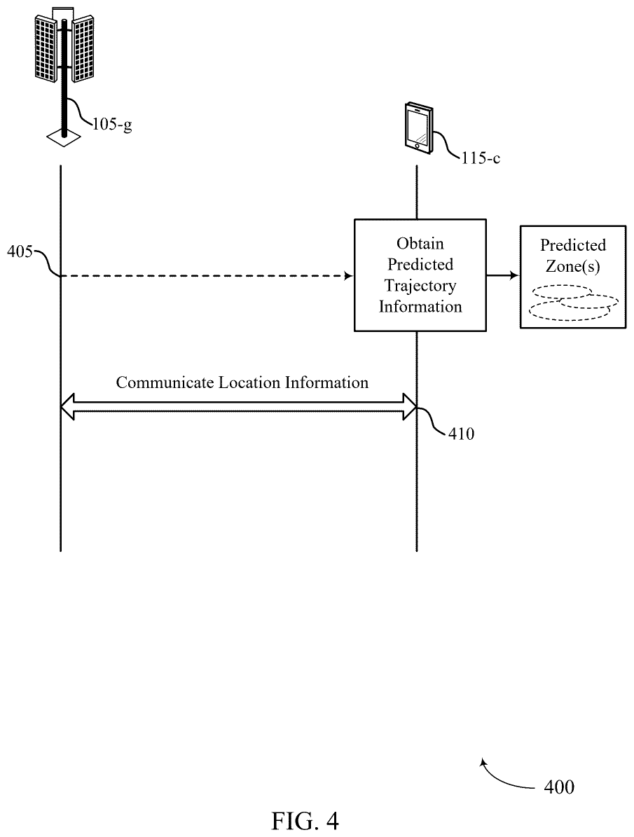

FIG. 4 shows an example of a process flow 400 that supports techniques for idle or inactive state trajectory predictions in accordance with one or more aspects of the present disclosure. The process flow 400 may implement or be implemented by aspects of the wireless communications system 100, the wireless communications system 200, or the wireless communications system 300. The process flow 400 may include a network entity 105-g and a UE 115-c, each of which may be examples of network entities and UEs described herein. In the following description of process flow 400, the operations may be performed in a different order than the order shown, or other operations may be added or removed from the process flow 400. For example, some operations may also be left out of process flow 400, may be performed in different orders or at different times, or other operations may be added to process flow 400. Although communications of the process flow 400 are shown occurring between a network entity 105-g and a UE 115-c, some aspects of some operations may also be performed by one or more other wireless devices, network devices, or network functions.

At 405, the UE 115-c may obtain (from the network entity 105-g, from one or more predictions performed by the UE 115-c, or from one or more other network devices or network functions) predicted trajectory information associated with the UE 115-c, which corresponds to a predicted trajectory of the UE 115-c while the UE 115-c operates in an idle or inactive mode. In some examples, the predicted trajectory information may indicate at least a predicted zone associated with the UE 115-c at a time instance after obtaining the predicted trajectory information. Additionally, or alternatively, the predicted trajectory information may be indicative of a respective duration that the location of the UE 115-c is predicted to be associated with the predicted zone, the time instance being within the respective duration. In some examples, the time instance is a first time instance, and the location of the UE 115-c at a second time instance (that occurs before the first time instance) may be associated with the predicted zone. In such examples, the predicted trajectory information further indicates a duration over which the location of the UE 115-c is predicted to be associated with the predicted zone.

In some aspects, a predicted zone may include a cell, a tracking area, a radio access network notification area, a beam, or one or more geo-location coordinates. In some aspects, a predicted zone may correspond to one or more signal strength parameters measured by the UE 115-c or the network entity 105-g. In some aspects, a predicted zone may correspond to a result of a sensing procedure performed by the UE 115-c

In some aspects, the UE 115-c may receive an indication of the predicted trajectory information from at least one network entity (e.g., the network entity 105-g, or one or more other network entities that are associated with a previous serving cell of the UE 115-c), a cell on which the UE 115-c is camped, a service of a core network of a wireless communication system associated with the UE 115-c, or any combination thereof. In some examples, the UE 115-c may receive the indication of the predicted trajectory information while operating in a connected mode (e.g., an RRC connected mode) associated with an active connection between the UE 115-c and the network entity 105-g. The UE 115-c may then transition from the connected mode to the idle or inactive mode based on receiving the indication. In some other examples, the UE 115-c may receive the indication based on a change in a location of the UE 115-c from a first zone to a second zone (or a change between multiple different zones)

In some aspects, the UE 115-c may obtain the predicted trajectory information associated with the UE 115-c using one or more machine learning models or other learning algorithms that are deployed at the UE 115-c. In some examples, the UE 115-c may transmit an indication of the predicted trajectory information to the network entity 105-g. For example, the UE 115-c may transmit the indication while the UE 115-c is operating in a connected mode associated with an active connection between the UE 115-c and the network entity 105-g, and may transition from the connected mode to the idle or inactive mode after transmitting the indication. Additionally, or alternatively, the UE 115-c may establish an active connection with the network entity 105-g and may transmit the indication to the network entity 105-g based on the established active connection.

In some aspects, transmission of the indication of the predicted trajectory information is in accordance with a procedure for updating the location of the UE 115-c. For example, the UE 115-c may receive, from the network entity 105-g, a periodicity indicator associated with the procedure, where the transmission of the indication is in accordance with a periodicity indicated by the periodicity indicator. In some cases, the UE 115-c may transmit an indicator of one or more parameters corresponding to the procedure, where transmitting the indication is in accordance with the one or more parameters. In some cases, the procedure includes a trajectory update procedure, and the UE 115-c may transmit the indication based on an actual trajectory of the UE 115-c while the UE 115-c operates in the idle or inactive mode, where the actual trajectory deviates from the predicted trajectory.

At 410, the UE 115-c may communicate, with the network entity 105-g, location information that is indicative of a location of the UE 115-c, where the location information may be based on the predicted trajectory information.

In some aspects, communicating the location information may include transmitting, to the network entity 105-g, an indication of whether the location of the UE 115-c at the time instance is consistent with the predicted trajectory information.

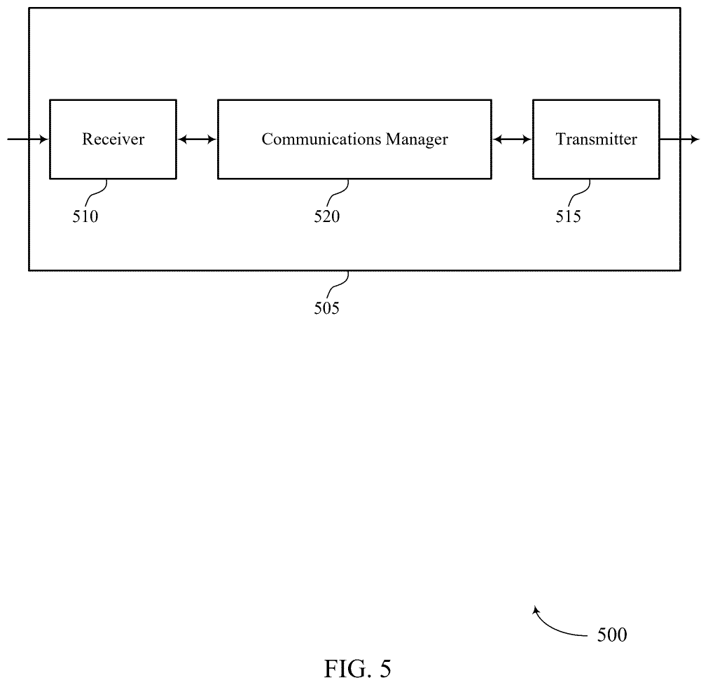

FIG. 5 shows a block diagram 500 of a device 505 that supports techniques for idle or inactive state trajectory predictions in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for idle or inactive state trajectory predictions). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for idle or inactive state trajectory predictions). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for idle or inactive state trajectory predictions as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 is capable of, configured to, or operable to support a means for obtaining predicted trajectory information associated with the UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information. The communications manager 520 is capable of, configured to, or operable to support a means for communicating, with a network entity, location information that is indicative of a location of the UE, the location information being based on the predicted trajectory information.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption due to reduced time spent in an RRC connected mode and relatively fewer communicated paging messages, reduced signaling overhead, reduced network power expenditure and signaling overhead, improved utilization of communications resources, enhanced integration of machine learning and AI techniques within wireless communications systems, among other possible advantages.

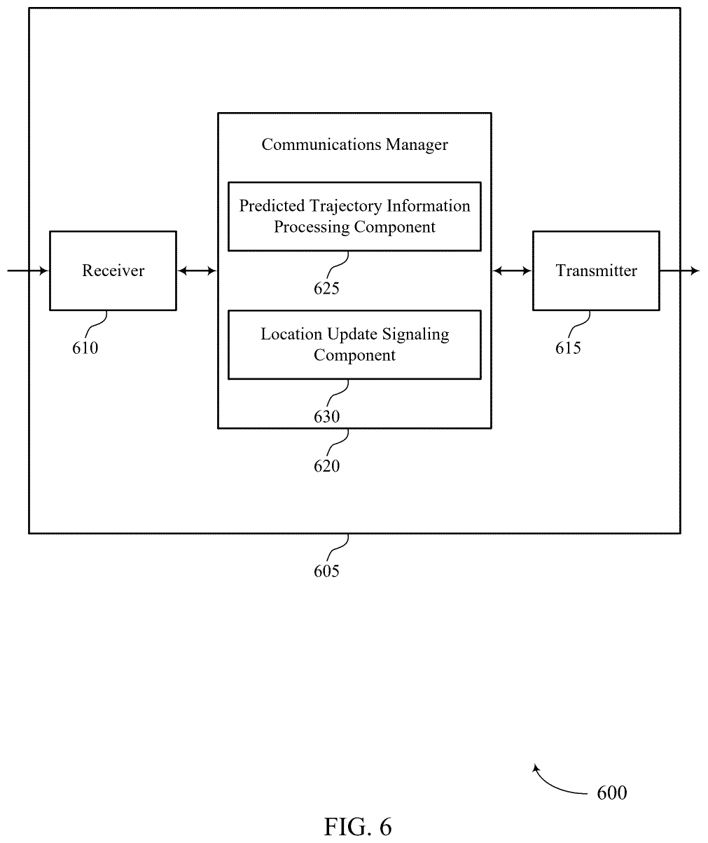

FIG. 6 shows a block diagram 600 of a device 605 that supports techniques for idle or inactive state trajectory predictions in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for idle or inactive state trajectory predictions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for idle or inactive state trajectory predictions). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for idle or inactive state trajectory predictions as described herein. For example, the communications manager 620 may include a predicted trajectory information processing component 625 a location update signaling component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The predicted trajectory information processing component 625 is capable of, configured to, or operable to support a means for obtaining predicted trajectory information associated with the UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information. The location update signaling component 630 is capable of, configured to, or operable to support a means for communicating, with a network entity, location information that is indicative of a location of the UE, the location information being based on the predicted trajectory information.

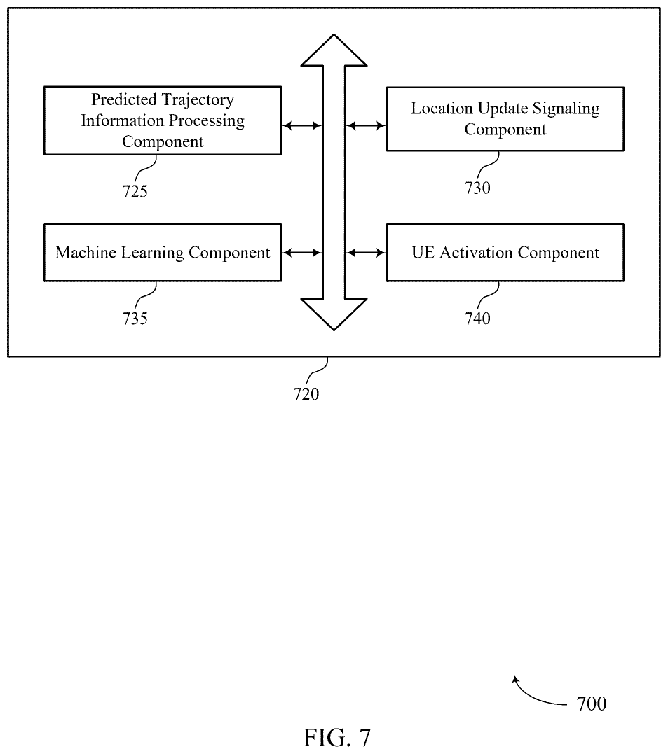

FIG. 7 shows a block diagram 700 of a communications manager 720 that supports techniques for idle or inactive state trajectory predictions in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for idle or inactive state trajectory predictions as described herein. For example, the communications manager 720 may include a predicted trajectory information processing component 725, a location update signaling component 730, a machine learning component 735, a UE activation component 740, or any combination thereof. Each of these components, or components or subcomponents thereof (e.g., one or more processors, one or more memories), may communicate, directly or indirectly, with one another (e.g., via one or more buses).

The communications manager 720 may support wireless communication in accordance with examples as disclosed herein. The predicted trajectory information processing component 725 is capable of, configured to, or operable to support a means for obtaining predicted trajectory information associated with the UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information. The location update signaling component 730 is capable of, configured to, or operable to support a means for communicating, with a network entity, location information that is indicative of a location of the UE, the location information being based on the predicted trajectory information.

In some examples, to support obtaining the predicted trajectory information, the predicted trajectory information processing component 725 is capable of, configured to, or operable to support a means for receiving an indication of the predicted trajectory information from at least one network entity, where the at least one network entity is associated with a previous serving cell of the UE, a cell on which the UE is camped, a service of a core network of a wireless communication system associated with the UE, or any combination thereof.

In some examples, to support receiving the indication, the predicted trajectory information processing component 725 is capable of, configured to, or operable to support a means for receiving the indication while operating in a connected mode associated with an active connection between the UE and the network entity. In some examples, to support receiving the indication, the UE activation component 740 is capable of, configured to, or operable to support a means for transitioning, after receiving the indication, from the connected mode to the idle or inactive mode.

In some examples, to support receiving the indication, the predicted trajectory information processing component 725 is capable of, configured to, or operable to support a means for receiving the indication based on a change in the location of the UE from a first zone to a second zone.

In some examples, to support obtaining the predicted trajectory information, the machine learning component 735 is capable of, configured to, or operable to support a means for obtaining the predicted trajectory information based on a machine learning model that is deployed at the UE.

In some examples, to support communicating the location information, the location update signaling component 730 is capable of, configured to, or operable to support a means for transmitting an indication of the predicted trajectory information to the network entity.

In some examples, to support transmitting the indication, the location update signaling component 730 is capable of, configured to, or operable to support a means for transmitting the indication while the UE operates in a connected mode associated with an active connection between the UE and the network entity. In some examples, to support transmitting the indication, the UE activation component 740 is capable of, configured to, or operable to support a means for transitioning, after transmitting the indication, from the connected mode to the idle or inactive mode.

In some examples, to support transmitting the indication, the UE activation component 740 is capable of, configured to, or operable to support a means for establishing an active connection with the network entity. In some examples, to support transmitting the indication, the location update signaling component 730 is capable of, configured to, or operable to support a means for transmitting the indication to the network entity based on establishing the active connection.

In some examples, transmission of the indication is in accordance with a procedure for updating the location of the UE.

In some examples, the location update signaling component 730 is capable of, configured to, or operable to support a means for receiving, from the network entity, a periodicity indicator associated with the procedure, where transmission of the indication is in accordance with a periodicity indicated by the periodicity indicator.

In some examples, the location update signaling component 730 is capable of, configured to, or operable to support a means for transmitting, to the network entity, an indicator of one or more parameters corresponding to the procedure, where transmitting the indication is in accordance with the one or more parameters.

In some examples, to support transmitting the indication, the location update signaling component 730 is capable of, configured to, or operable to support a means for transmitting the indication based on an actual trajectory of the UE while the UE operates in the idle or inactive mode, where the actual trajectory deviates from the predicted trajectory.

In some examples, to support communicating the location information, the location update signaling component 730 is capable of, configured to, or operable to support a means for transmitting, to the network entity, an indication of whether the location of the UE at the time instance is consistent with the predicted trajectory information, the indication including the location information.

In some examples, the predicted zone includes a cell, a tracking area, a radio access network notification area, a beam, or one or more geo-location coordinates. In some examples, the predicted zone corresponds to one or more signal strength measurement parameters. In some examples, the predicted zone corresponds to a result of a sensing procedure at the UE.

In some examples, the predicted trajectory information is further indicative of a respective duration the location of the UE is predicted to be associated with the predicted zone, the time instance being within the respective duration.

In some examples, the time instance is a first time instance. In some examples, the location of the UE at a second time instance before the first time instance is associated with the predicted zone. In some examples, the predicted trajectory information further indicates a duration over which the location of the UE is predicted to be associated with the predicted zone.

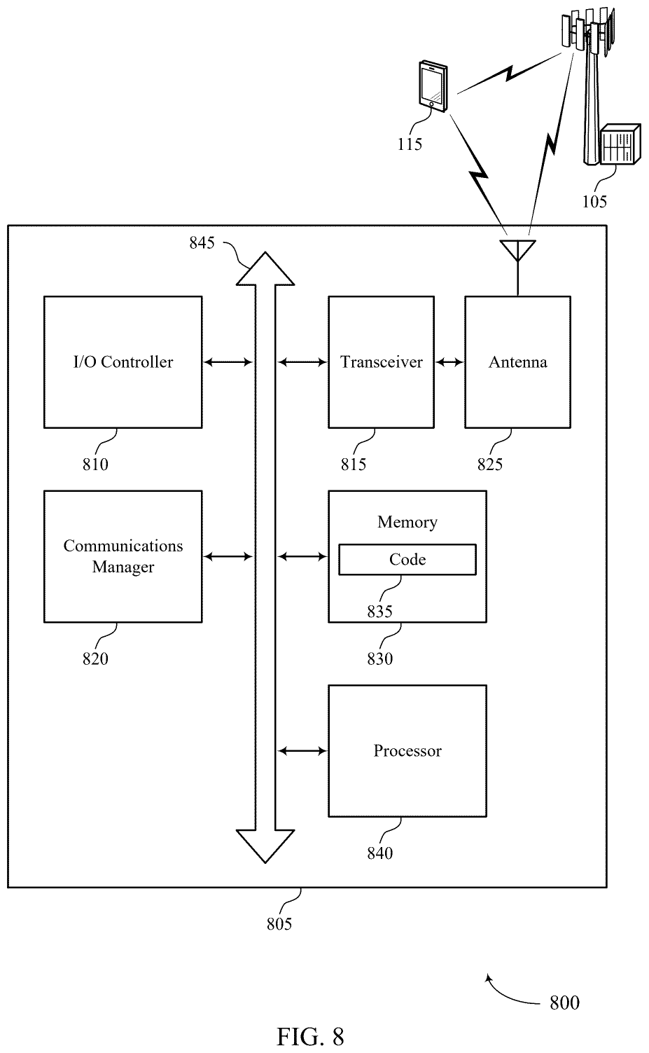

FIG. 8 shows a diagram of a system 800 including a device 805 that supports techniques for idle or inactive state trajectory predictions in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for idle or inactive state trajectory predictions). For example, the device 805 or a component of the device 805 may include at least one processor 840 and at least one memory 830 coupled with or to the at least one processor 840, the at least one processor 840 and the at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communication in accordance with examples as disclosed herein. For example, the communications manager 820 is capable of, configured to, or operable to support a means for obtaining predicted trajectory information associated with the UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information. The communications manager 820 is capable of, configured to, or operable to support a means for communicating, with a network entity, location information that is indicative of a location of the UE, the location information being based on the predicted trajectory information.

By including or configuring the communications manager 820 in accordance with examples as described herein, the device 805 may support techniques for improved communication reliability, reduced latency, improved user experience related to reduced processing, improved coordination between devices due to enhanced trajectory prediction, longer battery life due to reduced time spent in an active or connected state and due to reduced paging signaling and tracking update signaling overhead, improved utilization of processing capability, reduced power consumption due to reduced time spent in an RRC connected mode and relatively fewer communicated paging messages, reduced signaling overhead, reduced network power expenditure and signaling overhead, improved utilization of communications resources, enhanced integration of machine learning and AI techniques within wireless communications systems, among other possible advantages.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for idle or inactive state trajectory predictions as described herein, or the at least one processor 840 and the at least one memory 830 may be otherwise configured to, individually or collectively, perform or support such operations.

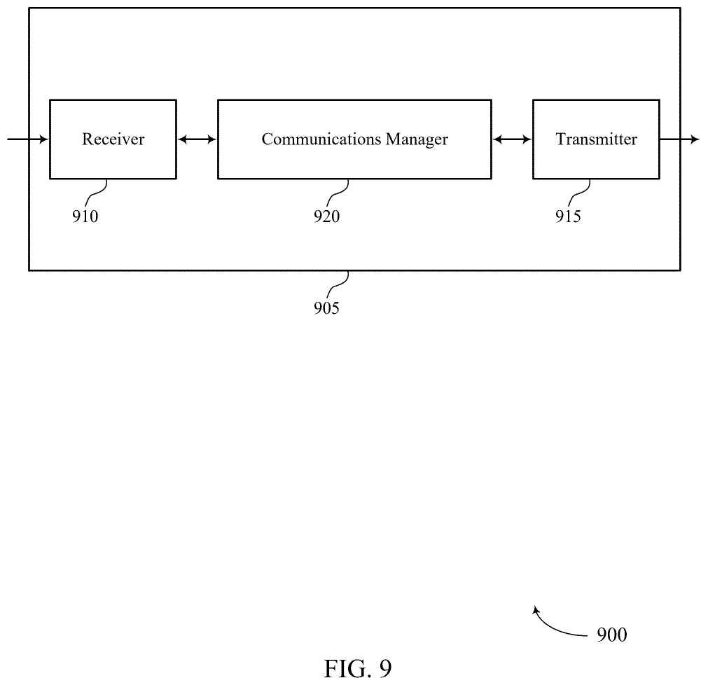

FIG. 9 shows a block diagram 900 of a device 905 that supports techniques for idle or inactive state trajectory predictions in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for idle or inactive state trajectory predictions as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 is capable of, configured to, or operable to support a means for obtaining predicted trajectory information associated with a UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information. The communications manager 920 is capable of, configured to, or operable to support a means for communicating location information that is indicative of a location of the UE, the location information being based on the predicted trajectory information.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption due to reduced time spent in an RRC connected mode and relatively fewer communicated paging messages, reduced signaling overhead, reduced network power expenditure and signaling overhead, improved utilization of communications resources, enhanced integration of machine learning and AI techniques within wireless communications systems, among other possible advantages.

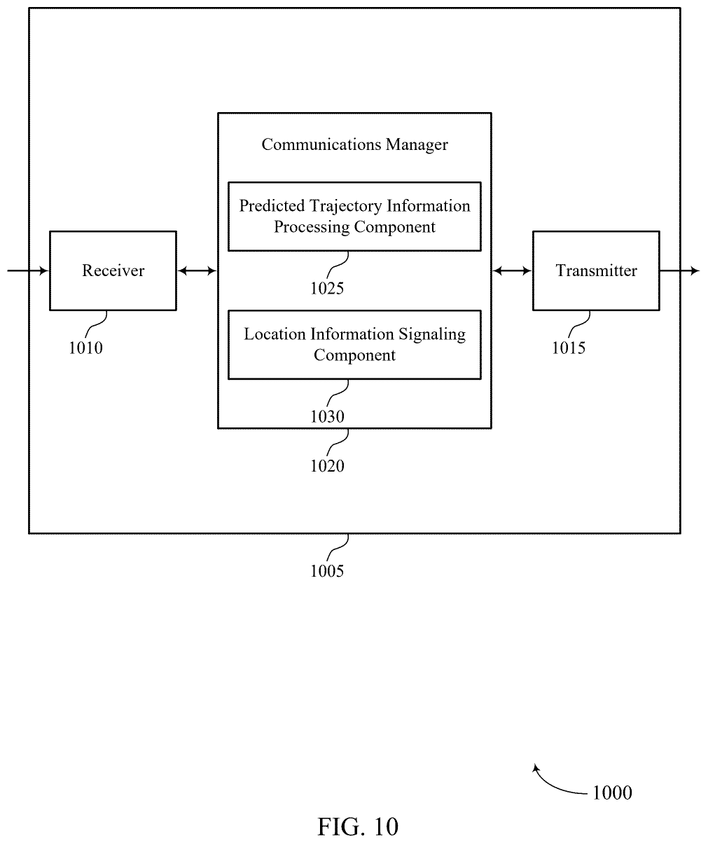

FIG. 10 shows a block diagram 1000 of a device 1005 that supports techniques for idle or inactive state trajectory predictions in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for idle or inactive state trajectory predictions as described herein. For example, the communications manager 1020 may include a predicted trajectory information processing component 1025 a location information signaling component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The predicted trajectory information processing component 1025 is capable of, configured to, or operable to support a means for obtaining predicted trajectory information associated with a UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information. The location information signaling component 1030 is capable of, configured to, or operable to support a means for communicating location information that is indicative of a location of the UE, the location information being based on the predicted trajectory information.

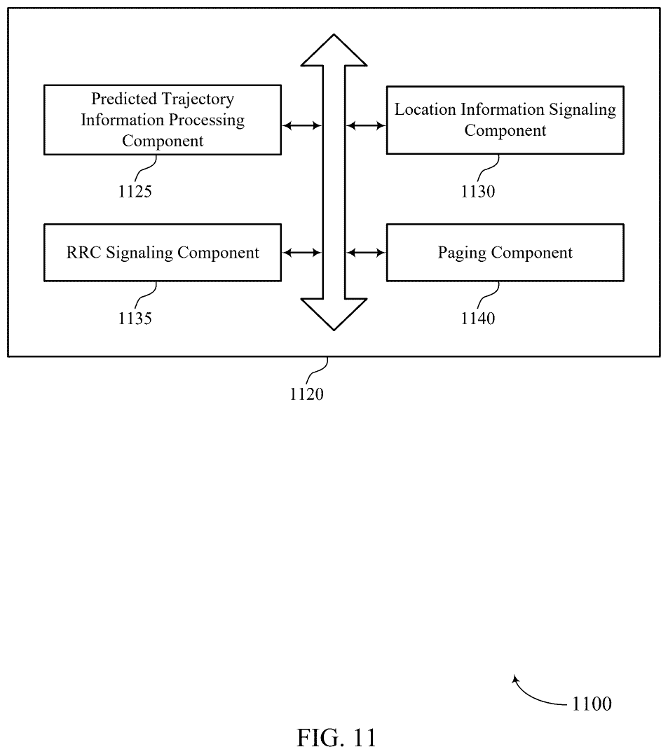

FIG. 11 shows a block diagram 1100 of a communications manager 1120 that supports techniques for idle or inactive state trajectory predictions in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for idle or inactive state trajectory predictions as described herein. For example, the communications manager 1120 may include a predicted trajectory information processing component 1125, a location information signaling component 1130, an RRC signaling component 1135, a paging component 1140, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication in accordance with examples as disclosed herein. The predicted trajectory information processing component 1125 is capable of, configured to, or operable to support a means for obtaining predicted trajectory information associated with a UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information. The location information signaling component 1130 is capable of, configured to, or operable to support a means for communicating location information that is indicative of a location of the UE, the location information being based on the predicted trajectory information.

In some examples, to support communicating the location information, the location information signaling component 1130 is capable of, configured to, or operable to support a means for outputting an indication of the predicted trajectory information to the UE or at least one other network entity.

In some examples, to support outputting the indication, the location information signaling component 1130 is capable of, configured to, or operable to support a means for outputting the indication based on an active connection between the UE and the network entity. In some examples, to support outputting the indication, the RRC signaling component 1135 is capable of, configured to, or operable to support a means for determining to release the active connection between the UE and the network entity after outputting the indication.

In some examples, to support outputting the indication, the location information signaling component 1130 is capable of, configured to, or operable to support a means for outputting the indication based on a change in the location of the UE from a first zone to a second zone.

In some examples, to support obtaining the predicted trajectory information, the predicted trajectory information processing component 1125 is capable of, configured to, or operable to support a means for obtaining an indication of the predicted trajectory information from the UE or at least one other network entity.

In some examples, the indication is obtained from the at least one other network entity, and the paging component 1140 is capable of, configured to, or operable to support a means for outputting a paging signal to the UE in response to obtaining the indication.

In some examples, to support obtaining the indication, the predicted trajectory information processing component 1125 is capable of, configured to, or operable to support a means for obtaining the indication from the UE via an active connection between the UE and the network entity. In some examples, to support obtaining the indication, the RRC signaling component 1135 is capable of, configured to, or operable to support a means for determining to release the active connection between the UE and the network entity after obtaining the indication. In some examples, the indication is obtained from the UE in accordance with a procedure for updating the location of the UE.

In some examples, the predicted trajectory information processing component 1125 is capable of, configured to, or operable to support a means for outputting a periodicity indicator associated with the procedure, where the indication is obtained in accordance with a periodicity indicated by the periodicity indicator.

In some examples, the predicted trajectory information processing component 1125 is capable of, configured to, or operable to support a means for obtaining an indicator of one or more parameters corresponding to the procedure, where the indication is obtained in accordance with the one or more parameters.

In some examples, to support obtaining the indication, the predicted trajectory information processing component 1125 is capable of, configured to, or operable to support a means for obtaining the indication based on an actual trajectory of the UE while the UE operates in the idle or inactive mode, where the actual trajectory deviates from the predicted trajectory.

In some examples, to support communicating the location information, the predicted trajectory information processing component 1125 is capable of, configured to, or operable to support a means for obtaining an indication of whether the location of the UE at the time instance is consistent with the predicted trajectory information, the indication including the location information.

In some examples, the predicted zone includes a cell, a tracking area, a radio access network notification area, a beam, or one or more geo-location coordinates. In some examples, the predicted zone corresponds to one or more signal strength measurement parameters. In some examples, the predicted trajectory information is further indicative of a respective duration the location of the UE is predicted to be associated with the predicted zone, the time instance being within the respective duration.

In some examples, the time instance is a first time instance. In some examples, the location of the UE at a second time instance before the first time instance is associated with the predicted zone. In some examples, the predicted trajectory information further indicates a duration over which the location of the UE is predicted to be associated with the predicted zone.

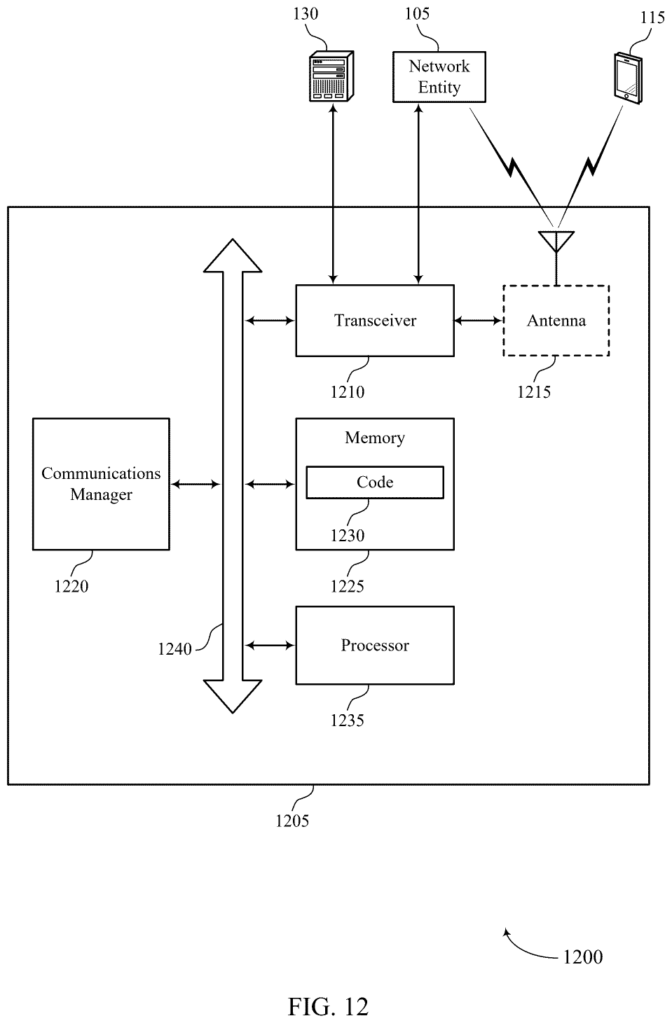

FIG. 12 shows a diagram of a system 1200 including a device 1205 that supports techniques for idle or inactive state trajectory predictions in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for idle or inactive state trajectory predictions). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network devices 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communication in accordance with examples as disclosed herein. For example, the communications manager 1220 is capable of, configured to, or operable to support a means for obtaining predicted trajectory information associated with a UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information. The communications manager 1220 is capable of, configured to, or operable to support a means for communicating location information that is indicative of a location of the UE, the location information being based on the predicted trajectory information.

By including or configuring the communications manager 1220 in accordance with examples as described herein, the device 1205 may support techniques for improved communication reliability, reduced latency, improved user experience related to reduced processing, improved coordination between devices due to enhanced trajectory prediction, longer battery life due to reduced time spent in an active or connected state and due to reduced paging signaling and tracking update signaling overhead, improved utilization of processing capability, reduced power consumption due to reduced time spent in an RRC connected mode and relatively fewer communicated paging messages, reduced signaling overhead, reduced network power expenditure and signaling overhead, improved utilization of communications resources, enhanced integration of machine learning and AI techniques within wireless communications systems, among other possible advantages.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for idle or inactive state trajectory predictions as described herein, or the at least one processor 1235 and the at least one memory 1225 may be otherwise configured to, individually or collectively, perform or support such operations.

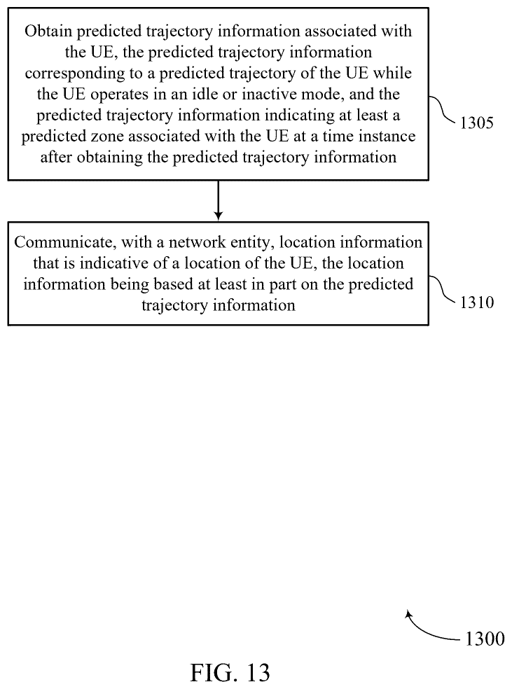

FIG. 13 shows a flowchart illustrating a method 1300 that supports techniques for idle or inactive state trajectory predictions in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include obtaining predicted trajectory information associated with the UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information. The operations of 1305 may be performed in accordance with examples as disclosed herein. In some examples, aspects of the operations of 1305 may be performed by a predicted trajectory information processing component 725 as described with reference to FIG. 7.

At 1310, the method may include communicating, with a network entity, location information that is indicative of a location of the UE, the location information being based at least in part on the predicted trajectory information. The operations of 1310 may be performed in accordance with examples as disclosed herein. In some examples, aspects of the operations of 1310 may be performed by a location update signaling component 730 as described with reference to FIG. 7.

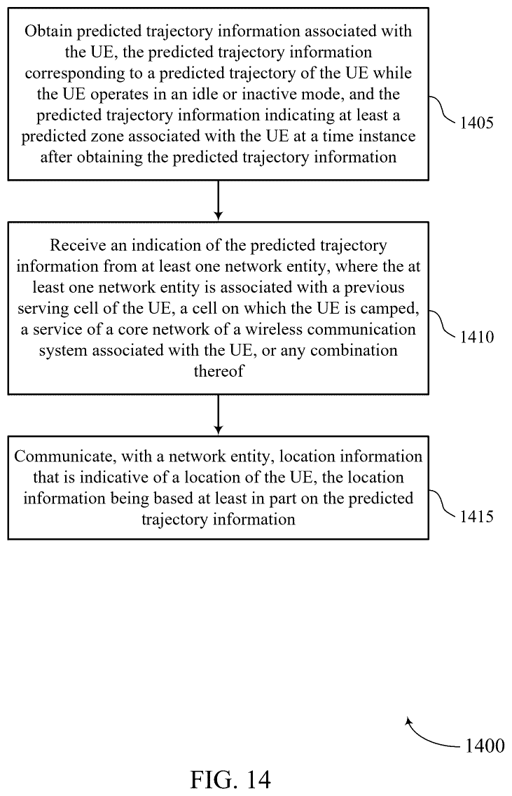

FIG. 14 shows a flowchart illustrating a method 1400 that supports techniques for idle or inactive state trajectory predictions in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include obtaining predicted trajectory information associated with the UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information. The operations of 1405 may be performed in accordance with examples as disclosed herein. In some examples, aspects of the operations of 1405 may be performed by a predicted trajectory information processing component 725 as described with reference to FIG. 7.

At 1410, the method may include receiving an indication of the predicted trajectory information from at least one network entity, where the at least one network entity is associated with a previous serving cell of the UE, a cell on which the UE is camped, a service of a core network of a wireless communication system associated with the UE, or any combination thereof. The operations of 1410 may be performed in accordance with examples as disclosed herein. In some examples, aspects of the operations of 1410 may be performed by a predicted trajectory information processing component 725 as described with reference to FIG. 7.

At 1415, the method may include communicating, with a network entity, location information that is indicative of a location of the UE, the location information being based at least in part on the predicted trajectory information. The operations of 1415 may be performed in accordance with examples as disclosed herein. In some examples, aspects of the operations of 1415 may be performed by a location update signaling component 730 as described with reference to FIG. 7.

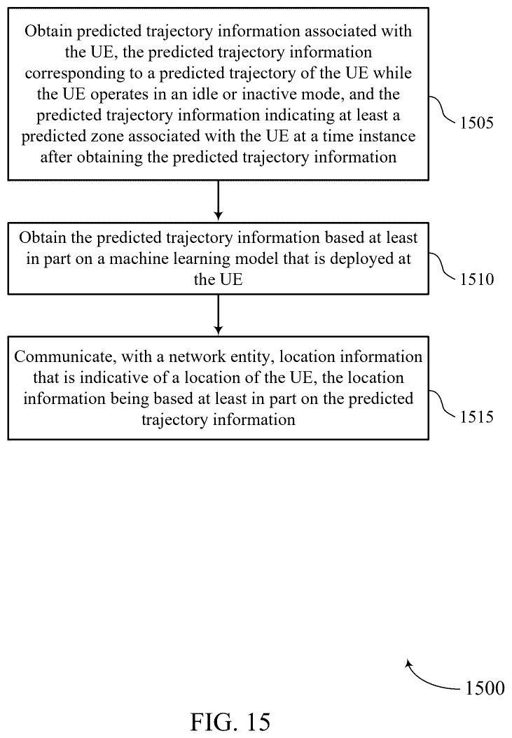

FIG. 15 shows a flowchart illustrating a method 1500 that supports techniques for idle or inactive state trajectory predictions in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include obtaining predicted trajectory information associated with the UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information. The operations of 1505 may be performed in accordance with examples as disclosed herein. In some examples, aspects of the operations of 1505 may be performed by a predicted trajectory information processing component 725 as described with reference to FIG. 7.

At 1510, the method may include obtaining the predicted trajectory information based at least in part on a machine learning model that is deployed at the UE. The operations of 1510 may be performed in accordance with examples as disclosed herein. In some examples, aspects of the operations of 1510 may be performed by a machine learning component 735 as described with reference to FIG. 7.

At 1515, the method may include communicating, with a network entity, location information that is indicative of a location of the UE, the location information being based at least in part on the predicted trajectory information. The operations of 1515 may be performed in accordance with examples as disclosed herein. In some examples, aspects of the operations of 1515 may be performed by a location update signaling component 730 as described with reference to FIG. 7.

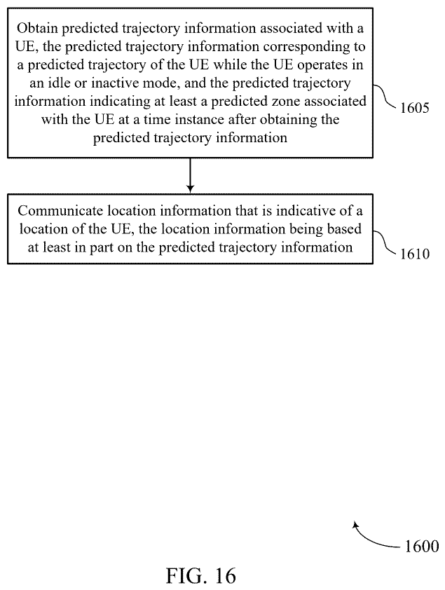

FIG. 16 shows a flowchart illustrating a method 1600 that supports techniques for idle or inactive state trajectory predictions in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include obtaining predicted trajectory information associated with a UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information. The operations of 1605 may be performed in accordance with examples as disclosed herein. In some examples, aspects of the operations of 1605 may be performed by a predicted trajectory information processing component 1125 as described with reference to FIG. 11.

At 1610, the method may include communicating location information that is indicative of a location of the UE, the location information being based at least in part on the predicted trajectory information. The operations of 1610 may be performed in accordance with examples as disclosed herein. In some examples, aspects of the operations of 1610 may be performed by a location information signaling component 1130 as described with reference to FIG. 11.

The following provides an overview of aspects of the present disclosure:

Aspect 1: A method for wireless communication by a UE, comprising: obtaining predicted trajectory information associated with the UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information; and communicating, with a network entity, location information that is indicative of a location of the UE, the location information being based at least in part on the predicted trajectory information.

Aspect 2: The method of aspect 1, wherein obtaining the predicted trajectory information comprises: receiving an indication of the predicted trajectory information from at least one network entity, wherein the at least one network entity is associated with a previous serving cell of the UE, a cell on which the UE is camped, a service of a core network of a wireless communication system associated with the UE, or any combination thereof.

Aspect 3: The method of aspect 2, wherein receiving the indication comprises: receiving the indication while operating in a connected mode associated with an active connection between the UE and the network entity; and transitioning, after receiving the indication, from the connected mode to the idle or inactive mode.

Aspect 4: The method of any of aspects 2 through 3, wherein receiving the indication comprises: receiving the indication based at least in part on a change in the location of the UE from a first zone to a second zone.

Aspect 5: The method of any of aspects 1 through 4, wherein obtaining the predicted trajectory information comprises: obtaining the predicted trajectory information based at least in part on a machine learning model that is deployed at the UE.

Aspect 6: The method of any of aspects 1 through 5, wherein communicating the location information comprises: transmitting an indication of the predicted trajectory information to the network entity.

Aspect 7: The method of aspect 6, wherein transmitting the indication comprises: transmitting the indication while the UE operates in a connected mode associated with an active connection between the UE and the network entity; and transitioning, after transmitting the indication, from the connected mode to the idle or inactive mode.

Aspect 8: The method of any of aspects 6 through 7, wherein transmitting the indication comprises: establishing an active connection with the network entity; and transmitting the indication to the network entity based at least in part on establishing the active connection.

Aspect 9: The method of any of aspects 6 through 8, wherein transmission of the indication is in accordance with a procedure for updating the location of the UE.

Aspect 10: The method of aspect 9, further comprising: receiving, from the network entity, a periodicity indicator associated with the procedure, where transmission of the indication is in accordance with a periodicity indicated by the periodicity indicator.

Aspect 11: The method of any of aspects 9 through 10, further comprising: transmitting, to the network entity, an indicator of one or more parameters corresponding to the procedure, wherein transmitting the indication is in accordance with the one or more parameters.

Aspect 12: The method of any of aspects 9 through 11, wherein the procedure comprises a trajectory update procedure, and wherein transmitting the indication comprises: transmitting the indication based at least in part on an actual trajectory of the UE while the UE operates in the idle or inactive mode, wherein the actual trajectory deviates from the predicted trajectory.

Aspect 13: The method of any of aspects 1 through 12, wherein communicating the location information comprises: transmitting, to the network entity, an indication of whether the location of the UE at the time instance is consistent with the predicted trajectory information, the indication comprising the location information.

Aspect 14: The method of any of aspects 1 through 13, wherein the predicted zone comprises a cell, a tracking area, a RAN notification area, a beam, or one or more geo-location coordinates.

Aspect 15: The method of any of aspects 1 through 14, wherein the predicted zone corresponds to one or more signal strength measurement parameters.

Aspect 16: The method of any of aspects 1 through 15, wherein the predicted zone corresponds to a result of a sensing procedure at the UE.

Aspect 17: The method of any of aspects 1 through 16, wherein the predicted trajectory information is further indicative of a respective duration the location of the UE is predicted to be associated with the predicted zone, the time instance being within the respective duration.

Aspect 18: The method of any of aspects 1 through 17, wherein the time instance is a first time instance, and the location of the UE at a second time instance before the first time instance is associated with the predicted zone, and the predicted trajectory information further indicates a duration over which the location of the UE is predicted to be associated with the predicted zone.

Aspect 19: A method for wireless communication by a network entity, comprising: obtaining predicted trajectory information associated with a UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information; and communicating location information that is indicative of a location of the UE, the location information being based at least in part on the predicted trajectory information.

Aspect 20: The method of aspect 19, wherein communicating the location information comprises: outputting an indication of the predicted trajectory information to the UE or at least one other network entity.

Aspect 21: The method of aspect 20, wherein outputting the indication comprises: outputting the indication based at least in part on an active connection between the UE and the network entity; and determining to release the active connection between the UE and the network entity after outputting the indication.

Aspect 22: The method of any of aspects 20 through 21, wherein outputting the indication comprises: outputting the indication based at least in part on a change in the location of the UE from a first zone to a second zone.

Aspect 23: The method of any of aspects 19 through 22, wherein obtaining the predicted trajectory information comprises: obtaining an indication of the predicted trajectory information from the UE or at least one other network entity.

Aspect 24: The method of aspect 23, wherein the indication is obtained from the at least one other network entity, and wherein the method further comprises: outputting a paging signal to the UE in response to obtaining the indication.

Aspect 25: The method of any of aspects 23 through 24, wherein obtaining the indication comprises: obtaining the indication from the UE via an active connection between the UE and the network entity; and determining to release the active connection between the UE and the network entity after obtaining the indication.

Aspect 26: The method of any of aspects 23 through 25, wherein the indication is obtained from the UE in accordance with a procedure for updating the location of the UE.

Aspect 27: The method of aspect 26, further comprising: outputting a periodicity indicator associated with the procedure, where the indication is obtained in accordance with a periodicity indicated by the periodicity indicator.

Aspect 28: The method of any of aspects 26 through 27, further comprising: obtaining an indicator of one or more parameters corresponding to the procedure, wherein the indication is obtained in accordance with the one or more parameters.

Aspect 29: The method of any of aspects 26 through 28, wherein the procedure comprises a trajectory update procedure, and wherein obtaining the indication comprises: obtaining the indication based at least in part on an actual trajectory of the UE while the UE operates in the idle or inactive mode, wherein the actual trajectory deviates from the predicted trajectory.

Aspect 30: The method of any of aspects 19 through 29, wherein communicating the location information comprises: obtaining an indication of whether the location of the UE at the time instance is consistent with the predicted trajectory information, the indication comprising the location information.

Aspect 31: The method of any of aspects 19 through 30, wherein the predicted zone comprises a cell, a tracking area, a radio access network notification area, a beam, or one or more geo-location coordinates.

Aspect 32: The method of any of aspects 19 through 31, wherein the predicted zone corresponds to one or more signal strength measurement parameters.

Aspect 33: The method of any of aspects 19 through 32, wherein the predicted trajectory information is further indicative of a respective duration the location of the UE is predicted to be associated with the predicted zone, the time instance being within the respective duration.

Aspect 34: The method of any of aspects 19 through 33, wherein the time instance is a first time instance, and the location of the UE at a second time instance before the first time instance is associated with the predicted zone, and the predicted trajectory information further indicates a duration over which the location of the UE is predicted to be associated with the predicted zone.

Aspect 35: A UE for wireless communication, comprising one or more memories storing processor-executable code, and one or more processors coupled with the one or more memories and individually or collectively operable to execute the code to cause the UE to perform a method of any of aspects 1 through 18.

Aspect 36: A UE for wireless communication, comprising at least one means for performing a method of any of aspects 1 through 18.

Aspect 37: A non-transitory computer-readable medium storing code for wireless communication, the code comprising instructions executable by one or more processors to perform a method of any of aspects 1 through 18.

Aspect 38: A network entity for wireless communication, comprising one or more memories storing processor-executable code, and one or more processors coupled with the one or more memories and individually or collectively operable to execute the code to cause the network entity to perform a method of any of aspects 19 through 34.

Aspect 39: A network entity for wireless communication, comprising at least one means for performing a method of any of aspects 19 through 34.

Aspect 40: A non-transitory computer-readable medium storing code for wireless communication, the code comprising instructions executable by one or more processors to perform a method of any of aspects 19 through 34.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
obtain predicted trajectory information associated with the UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information; and
communicate, with a network entity, location information that is indicative of a location of the UE, the location information being based at least in part on the predicted trajectory information.

2. The UE of claim 1, wherein, to obtain the predicted trajectory information, the one or more processors are individually or collectively operable to execute the code to cause the UE to:
receive an indication of the predicted trajectory information from at least one network entity, wherein the at least one network entity is associated with a previous serving cell of the UE, a cell on which the UE is camped, a service of a core network of a wireless communication system associated with the UE, or any combination thereof.

3. The UE of claim 2, wherein, to receive the indication, the one or more processors are individually or collectively operable to execute the code to cause the UE to:
receive the indication while operating in a connected mode associated with an active connection between the UE and the network entity; and
transition, after receiving the indication, from the connected mode to the idle or inactive mode.

4. The UE of claim 2, wherein, to receive the indication, the one or more processors are individually or collectively operable to execute the code to cause the UE to:
receive the indication based at least in part on a change in the location of the UE from a first zone to a second zone.

5. The UE of claim 1, wherein, to obtain the predicted trajectory information, the one or more processors are individually or collectively operable to execute the code to cause the UE to:
obtain the predicted trajectory information based at least in part on a machine learning model that is deployed at the UE.

6. The UE of claim 1, wherein, to communicate the location information, the one or more processors are individually or collectively operable to execute the code to cause the UE to:
transmit an indication of the predicted trajectory information to the network entity.

7. The UE of claim 6, wherein, to transmit the indication, the one or more processors are individually or collectively operable to execute the code to cause the UE to:
transmit the indication while the UE operates in a connected mode associated with an active connection between the UE and the network entity; and
transition, after transmitting the indication, from the connected mode to the idle or inactive mode.

8. The UE of claim 6, wherein, to transmit the indication, the one or more processors are individually or collectively operable to execute the code to cause the UE to:
establish an active connection with the network entity; and
transmit the indication to the network entity based at least in part on establishing the active connection.

9. The UE of claim 6, wherein transmission of the indication is in accordance with a procedure for updating the location of the UE.

10. The UE of claim 9, wherein the one or more processors are individually or collectively further operable to execute the code to cause the UE to:
receive, from the network entity, a periodicity indicator associated with the procedure, where transmission of the indication is in accordance with a periodicity indicated by the periodicity indicator.

11. The UE of claim 9, wherein the one or more processors are individually or collectively further operable to execute the code to cause the UE to:
transmit, to the network entity, an indicator of one or more parameters corresponding to the procedure, wherein transmitting the indication is in accordance with the one or more parameters.

12. The UE of claim 9, wherein, to transmit the indication, the one or more processors are individually or collectively operable to execute the code to cause the UE to:
transmit the indication based at least in part on an actual trajectory of the UE while the UE operates in the idle or inactive mode, wherein the actual trajectory deviates from the predicted trajectory.

13. The UE of claim 1, wherein, to communicate the location information, the one or more processors are individually or collectively operable to execute the code to cause the UE to:
transmit, to the network entity, an indication of whether the location of the UE at the time instance is consistent with the predicted trajectory information, the indication comprising the location information.

14. The UE of claim 1, wherein the predicted zone comprises a cell, a tracking area, a radio access network notification area, a beam, or one or more geo-location coordinates.

15. The UE of claim 1, wherein:
the predicted zone corresponds to one or more signal strength measurement parameters.

16. The UE of claim 1, wherein the predicted zone corresponds to a result of a sensing procedure at the UE.

17. The UE of claim 1, wherein the predicted trajectory information is further indicative of a respective duration the location of the UE is predicted to be associated with the predicted zone, the time instance being within the respective duration.

18. The UE of claim 1, wherein:
the time instance is a first time instance, and
the location of the UE at a second time instance before the first time instance is associated with the predicted zone, and
the predicted trajectory information further indicates a duration over which the location of the UE is predicted to be associated with the predicted zone.

19. A network entity, comprising:
one or more memories storing processor-executable code; and
one or more processors coupled with the one or more memories and individually or collectively operable to execute the code to cause the network entity to:
obtain predicted trajectory information associated with a user equipment (UE), the predicted trajectory information corresponding to a predicted trajectory of the UE while the UE operates in an idle or inactive mode, and the predicted trajectory information indicating at least a predicted zone associated with the UE at a time instance after obtaining the predicted trajectory information; and
communicate location information that is indicative of a location of the UE, the location information being based at least in part on the predicted trajectory information.

20. The network entity of claim 19, wherein, to communicate the location information, the one or more processors are individually or collectively operable to execute the code to cause the network entity to:
output an indication of the predicted trajectory information to the UE or at least one other network entity.

21. The network entity of claim 20, wherein, to output the indication, the one or more processors are individually or collectively operable to execute the code to cause the network entity to:
output the indication based at least in part on an active connection between the UE and the network entity; and
determine to release the active connection between the UE and the network entity after outputting the indication.

22. The network entity of claim 20, wherein, to output the indication, the one or more processors are individually or collectively operable to execute the code to cause the network entity to:
output the indication based at least in part on a change in the location of the UE from a first zone to a second zone.

23. The network entity of claim 19, wherein, to obtain the predicted trajectory information, the one or more processors are individually or collectively operable to execute the code to cause the network entity to:
obtain an indication of the predicted trajectory information from the UE or at least one other network entity.

24. The network entity of claim 23, wherein the indication is obtained from the at least one other network entity, and the one or more processors are individually or collectively further operable to execute the code to cause the network entity to:
output a paging signal to the UE in response to obtaining the indication.

25. The network entity of claim 23, wherein, to obtain the indication, the one or more processors are individually or collectively operable to execute the code to cause the network entity to:
obtain the indication from the UE via an active connection between the UE and the network entity; and
determine to release the active connection between the UE and the network entity after obtaining the indication.

26. The network entity of claim 23, wherein the indication is obtained from the UE in accordance with a procedure for updating the location of the UE, and wherein the one or more processors are individually or collectively further operable to execute the code to cause the network entity to:
output a periodicity indicator associated with the procedure, where the indication is obtained in accordance with a periodicity indicated by the periodicity indicator.

27. The network entity of claim 23, wherein the indication is obtained from the UE in accordance with a procedure for updating the location of the UE, and wherein to obtain the indication the one or more processors are individually or collectively operable to execute the code to cause the network entity to:
obtain the indication based at least in part on an actual trajectory of the UE while the UE operates in the idle or inactive mode, wherein the actual trajectory deviates from the predicted trajectory.

28. The network entity of claim 19, wherein, to communicate the location information, the one or more processors are individually or collectively operable to execute the code to cause the network entity to:
obtain an indication of whether the location of the UE at the time instance is consistent with the predicted trajectory information, the indication comprising the location information.

29. A method for wireless communication by a user equipment (UE), comprising:
obtaining predicted trajectory information associated with the UE, the predicted trajectory information corresponding to a predicted trajectory of the UE while the UE operates in an idle or inactive mode, and the predicted trajectory information indicating at least a predicted zone associated with the UE at a time instance after obtaining the predicted trajectory information; and
communicating, with a network entity, location information that is indicative of a location of the UE, the location information being based at least in part on the predicted trajectory information.

30. A method for wireless communication by a network entity, comprising:
obtaining predicted trajectory information associated with a user equipment (UE), the predicted trajectory information corresponding to a predicted trajectory of the UE while the UE operates in an idle or inactive mode, and the predicted trajectory information indicating at least a predicted zone associated with the UE at a time instance after obtaining the predicted trajectory information; and
communicating location information that is indicative of a location of the UE, the location information being based at least in part on the predicted trajectory information.
